(19) United States
(12) Patent Application Publication
(10) Pub. No.: US 2026/0044614 A1
(43) Pub. Date: Feb. 12, 2026

(54) SEARCH MANAGEMENT DEVICE, COMPUTER SYSTEM, AND SEARCH MANAGEMENT METHOD

(71) Applicant: Hitachi, Ltd., Tokyo (JP)

(72) Inventors: Kyohei YAMAMOTO, Tokyo (JP); Hisayoshi SATO, Tokyo (JP); Masayuki YOSHINO, Tokyo (JP)

(21) Appl. No.: 19/290,696

(22) Filed: Aug. 5, 2025

(30) Foreign Application Priority Data
Aug. 8, 2024 (JP) 2024-133172

(51) Int. Cl. G06F 21/60

(52) U.S. Cl. CPC G06F 21/602

(57) ABSTRACT

A prompt generation server stores encrypted storage data obtained by encrypting storage data with a common key and encrypted storage embedding data obtained by encrypting storage embedding data indicating a feature of the storage data with a searchable encryption key for each piece of the storage data in a search DB. The prompt generation server generates encrypted prompt embedding data obtained by encrypting prompt embedding data indicating a feature of a user prompt with a searchable encryption key, and transmits the encrypted prompt embedding data to a data management server. The prompt generation server receives encrypted related data which is encrypted storage data corresponding to the encrypted storage embedding data similar to encrypted target embedding data, decrypts the encrypted related data with the common key, and acquires related data.

### CROSS-REFERENCE TO RELATED APPLICATION

The present application claims priority from Japanese application JP2024-133172, filed on Aug. 8, 2024, the content of which is hereby incorporated by reference into this application.

### BACKGROUND OF THE INVENTION

### 1. Field of the Invention

The present disclosure relates to a search management device, a computer system, and a search management method.

### 2. Description of Related Art

Artificial intelligence (AI) has been used in various fields such as financial, medical, and manufacturing, and among them, large language model (LLM) is one of active examples in which AI is most widely used. As an efficient utilization method of the LLM, a technique called retrieval augmented generation (RAG) has attracted attention. The RAG is an AI framework that, when a prompt for the LLM is output from a user, searches a database for search prepared in advance for related data related to the prompt, generates a new prompt based on the prompt and the related data, and inputs the new prompt to the LLM. By using this technique, the quality of generation data generated by the LLM can be improved.

Security measures are also important in a RAG system, which is a system that is RAG-compliant. In particular, in a case where management of the database for search is outsourced, it is desirable to perform encryption of embedding data used for searching the related data in addition to encryption of storage data stored in the database for search in terms of security.

However, when the storage data and the embedding data are encrypted, a search becomes difficult, which adversely affects an operation of the RAG system. On the other hand, NPL 1 discloses a confidential Hamming distance calculation using homomorphic encryption. By using the confidential Hamming distance calculation, a confidential similarity search can be performed in which the embedding data is searched while being encrypted.

### CITATION LIST

### Non Patent Literature

NPL 1: Masaya Yasuda, four others, “Secure Pattern Matching using Somewhat Homomorphic Encryption”, In ACM workshop on Cloud computing security workshop-CCSW 2013, ACM, 65-76, 2013

### SUMMARY OF THE INVENTION

However, in a technique described in NPL 1, a reliable private key holder of a third party needs to decrypt a search result at the time of the confidential similarity search, and thus there remains a problem in efficient operation of the RAG system.

An object of the present disclosure is to provide a search management device, a computer system, and a search management method in which a secure and efficient confidential similarity search is possible.

A search management device according to an aspect of the present disclosure is a search management device configured to acquire related data related to search target data from a database, in which encrypted storage data obtained by encrypting storage data stored in the database and encrypted storage embedding data obtained by encrypting storage embedding data indicating a feature of the storage data with a searchable encryption key are generated for each piece of the storage data and stored in the database, encrypted target embedding data obtained by encrypting target embedding data indicating a feature of the search target data with the searchable encryption key is generated and transmitted to a data management device, the data management device searching for encrypted storage data corresponding to the encrypted storage embedding data similar to the encrypted target embedding data, the encrypted storage data searched for by the data management device is acquired as encrypted related data obtained by encrypting the related data, and the encrypted related data is decrypted to acquire the related data.

According to the present invention, a secure and efficient confidential similarity search can be performed.

### BRIEF DESCRIPTION OF THE DRAWINGS

FIG. 1 is a block diagram illustrating a configuration example of a RAG system according to an embodiment of the present disclosure.

FIG. 2 is a block diagram illustrating a hardware structure example of a user computer.

FIG. 3 is a block diagram illustrating a hardware structure example of a prompt generation server.

FIG. 4 is a block diagram illustrating a hardware structure example of an embedding generation server.

FIG. 5 is a block diagram illustrating a hardware structure example of a data management server.

FIG. 6 is a block diagram illustrating a hardware structure example of a generation AI server.

FIG. 7 is a sequence diagram illustrating an example of processing in a data storage phase.

FIG. 8 is a sequence diagram illustrating an example of processing in a generation AI use phase.

### DESCRIPTION OF EMBODIMENTS

Hereinafter, embodiments of the present disclosure will be described with reference to the drawings. In the present embodiment, components having the same function are denoted by the same reference numerals, and description thereof may be omitted. The present embodiment is merely an example for implementing the present disclosure and does not limit the technical scope of the invention.

### EMBODIMENTS

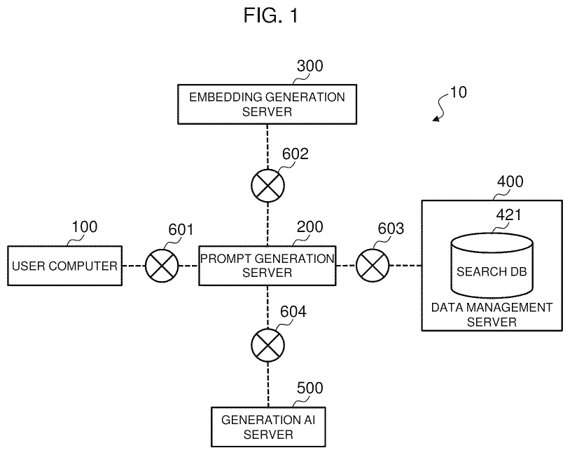

FIG. 1 is a block diagram illustrating a configuration example of a RAG system according to an embodiment of the present disclosure. In FIG. 1, a RAG system 10 is a computer system including a user computer 100, a prompt generation server 200, an embedding generation server 300, a data management server 400, and a generation AI server 500. The prompt generation server 200 is communicably connected to each of the user computer 100, the embedding generation server 300, the data management server 400, and the generation AI server 500 via each of communication networks 601 to 604.

Processing executed by the RAG system 10 is divided into a data storage phase of storing data in the data management server 400 and a generation AI use phase of utilizing a generation AI using the data stored in the storage phase. The data storage phase includes an initial setting phase of performing initial setting for storing data and an operation phase of actually storing the data.

The user computer 100 is a computer operated by a user who uses the RAG system 10.

In the data storage phase, the user computer 100 transmits storage data, which is data to be stored in the data management server 400, to the prompt generation server 200. The storage data may include, for example, information used in an organization to which the user belongs. In addition, the storage data functions as a candidate for related data to be described later.

In the generation AI use phase, the user computer 100 transmits a user prompt, which is an instruction for a generation AI model from the user, to the prompt generation server 200. In addition, the user computer 100 receives, from the prompt generation server 200, generation data generated by the generation AI model in response to the user prompt, and presents the generation data to the user.

The storage data and the user prompt include, for example, text data, image data, and audio data. The user prompt is searching target data for performing a similarity search to be described later.

The prompt generation server 200 is a computer which functions as a search management device that processes the user prompt from the user computer 100.

In the initial setting phase of the data storage phase, the prompt generation server 200 generates a data encryption key, a searchable encryption key, and a random shuffle key.

The data encryption key is an encryption key for encrypting the storage data to be stored in the data management server 400.

The searchable encryption key is an encryption key for performing searchable encryption in which embedding data for performing the similarity search of data is encrypted in a searchable state. The searchable encryption will be described in detail later.

The random shuffle key is an encryption key for performing random shuffle in which each bit of encrypted embedding data obtained by encrypting embedding data with a searchable encryption key is shuffled. The random shuffle will be described in detail later.

In the operation phase of the data storage phase, the prompt generation server 200 transmits the storage data received from the user computer 100 to the embedding generation server 300, and receives, from the embedding generation server 300, storage embedding data which is embedding data corresponding to the storage data. In addition, the prompt generation server 200 generates encrypted storage data obtained by encrypting the storage data with the data encryption key and encrypted storage embedding data obtained by encrypting the storage embedding data with the searchable encryption key, and transmits the encrypted storage data and the encrypted storage embedding data to the data management server 400.

In the generation AI use phase, the prompt generation server 200 transmits the user prompt received from the user computer 100 to the embedding generation server 300, and receives, from the embedding generation server 300, prompt embedding data which is embedding data corresponding to the user prompt. The prompt generation server 200 generates encrypted prompt embedding data obtained by encrypting the prompt embedding data with the searchable encryption key as a search query for searching for related data which is storage data related to the user prompt.

Further, the prompt generation server 200 transmits the search query to the data management server 400, and acquires encrypted storage data corresponding to the search query from the data management server 400 as encrypted related data obtained by encrypting the related data. The prompt generation server 200 decrypts the encrypted related data to acquire the related data, generates an input prompt based on the acquired related data and the user prompt, and transmits the input prompt to the generation AI server 500. The prompt generation server 200 receives generation data from the generation AI server 500 and transmits the received generation data to the user computer 100.

The embedding generation server 300 is a computer which functions as an embedding generation device that generates embedding data.

In the data storage phase, the embedding generation server 300 receives the storage data from the prompt generation server 200, generates storage embedding data which is embedding data corresponding to the storage data, and transmits the storage embedding data to the prompt generation server 200.

In the generation AI use phase, the embedding generation server 300 receives the user prompt from the prompt generation server 200, generates prompt embedding data which is embedding data corresponding to the user prompt, and transmits the prompt embedding data to the prompt generation server 200.

The embedding data is data indicating a feature of data (storage data and user prompt) of a generation source, and a similarity between pieces of the data of the generation source is reflected in the similarity between pieces of the embedding data. The embedding data is described by, for example, a numerical value vector.

The data management server 400 is a computer which functions as a data management device that manages storage data. In the present embodiment, the data management server 400 includes a search DB 421 which is a database for storing storage data.

In the data storage phase, the data management server 400 receives the encrypted storage data and the encrypted storage embedding data from the prompt generation server 200, and stores the encrypted storage data and the encrypted storage embedding data in the search DB 421 in association with each other.

In the generation AI use phase, the data management server 400 receives the search query (encrypted prompt embedding data) from the prompt generation server 200, performs a similarity search for searching the search DB 421 for encrypted storage embedding data similar to the search query, and transmits encrypted storage data corresponding to the encrypted storage embedding data, which is a search result, to the prompt generation server 200 as encrypted related data.

The generation AI server 500 is a computer which functions as a generation AI management device including a generation AI model learned in advance.

In the generation AI use phase, the generation AI server 500 inputs the input prompt received from the prompt generation server 200 to the generation AI model, and transmits the generation data output from the generation AI model to the prompt generation server 200.

The configuration of the RAG system 10 illustrated in FIG. 1 is merely an example, and the present invention is not limited thereto. For example, two or more computers illustrated in FIG. 1 may be implemented by a single computer. For example, the prompt generation server 200 and the embedding generation server 300 may be implemented by a single computer, or the prompt generation server 200, the embedding generation server 300, and the generation AI server 500 may be implemented by a single computer.

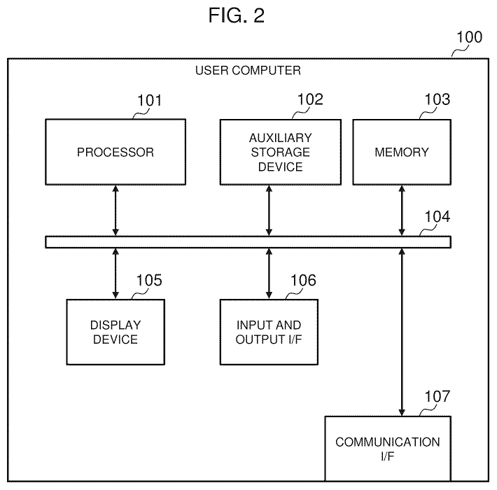

FIG. 2 is a block diagram illustrating a hardware structure example of the user computer 100. In FIG. 2, the user computer 100 is a computer including a processor 101, an auxiliary storage device 102, a memory 103, a display device 105, an input and output interface (I/F) 106, and a communication interface (I/F) 107, and the respective units are connected to each other via an internal signal line 104 such as a bus.

The processor 101 is, for example, a central processing unit (CPU), and is a processing device that executes a program stored in the memory 103 to integrally control each device. The memory 103 includes a read only memory (ROM) which is a non-volatile non-transitory storage element and a random access memory (RAM) which is a volatile storage element. The ROM stores a fixed program (for example, BIOS). The RAM is a high-speed and volatile storage element such as a dynamic random access memory (DRAM), and temporarily stores a program executed by the processor 101 and data used when the program is executed.

The auxiliary storage device 102 is, for example, a large-capacity and non-volatile non-transitory storage device such as a magnetic storage device (hard disk drive (HDD)) or a flash memory (solid state drive (SSD)), and stores a program executed by the processor 101 and data used when the program is executed. That is, the program is read from the auxiliary storage device 102, loaded into the memory 103, and then executed by the processor 101.

The input and output interface 106 is an interface that is connected to an input device such as a keyboard and a mouse and inputs information by an operation of an operator. The input and output interface 106 is also an interface that is connected to the display device 105 and an output device such as a printer, converts an execution result of a program into information in a format visible to the operator, and outputs the information. The display device 105 displays the execution result of the program output from the input and output interface 106. The display device 105 may be connected to the internal signal line 104 not via the input and output interface 106, and the form thereof is illustrated in the example of the drawing.

The communication interface 107 is a network interface that controls communication with another device according to a predetermined protocol. In addition, the communication interface 107 may include, for example, a serial interface such as a universal serial bus (USB).

A part or all of programs executed by the processor 101 may be provided to the user computer 100 from a removable medium (CD-ROM, flash memory, or the like) which is a non-transitory storage medium or from an external computer including a non-transitory storage device via the communication network 601, and may be stored in the non-volatile auxiliary storage device 102 which is a non-transitory storage medium. Therefore, the user computer 100 can be implemented to have an interface for reading data from a removable medium. The same applies to the prompt generation server 200, the embedding generation server 300, the data management server 400, and the generation AI server 500.

The user computer 100 is a computer system implemented on a single physical computer or a plurality of logically or physically configured computers, and may operate on the same computer with separate threads or on a virtual computer configured on a plurality of physical computer resources. The same applies to the prompt generation server 200, the embedding generation server 300, the data management server 400, and the generation AI server 500.

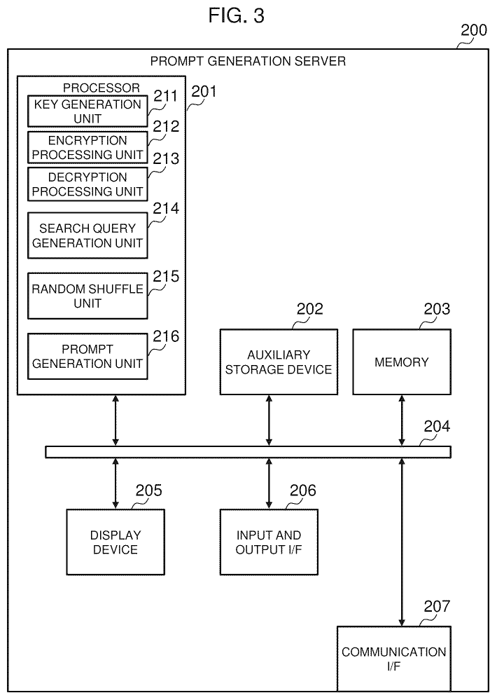

FIG. 3 is a block diagram illustrating a hardware structure example of the prompt generation server 200. In FIG. 3, the prompt generation server 200 is a computer including a processor 201, an auxiliary storage device 202, a memory 203, a display device 205, an input and output interface 206, and a communication interface 207, and the respective devices are connected to each other via an internal signal line 204 such as a bus.

Functions as hardware of the processor 201, the auxiliary storage device 202, the memory 203, the internal signal line 204, the display device 205, the input and output interface 206, and the communication interface 207 are the same as functions as hardware of the processor 101, the auxiliary storage device 102, the memory 103, the internal signal line 104, the display device 105, the input and output interface 106, and the communication interface 107, so that the description thereof will be omitted.

The processor 201 executes a program stored in the memory 203 to implement a key generation unit 211, an encryption processing unit 212, a decryption processing unit 213, a search query generation unit 214, a random shuffle unit 215, and a prompt generation unit 216, which are functional configurations.

The key generation unit 211 generates the above-described data encryption key, encrypted storage embedding data, and random shuffle key.

In the present embodiment, the key generation unit 211 uses a common key encryption method such as an advanced encryption standard (AES) as an encryption method used for data encryption which is encryption of storage data. In this case, the same data encryption key (common key) is used for encryption and decryption of the storage data.

The key generation unit 211 uses a common key-based searchable encryption method as an encryption method used for searchable encryption which is encryption of embedding data. In the present embodiment, the searchable encryption is used for the purpose of similarity search for acquiring related data related to the user prompt, and a distance between pieces of the embedding data is used as the similarity used for the similarity search. The distance between the pieces of the embedding data is, for example, a Euclidean distance or a Hamming distance. The searchable encryption method will be described in more detail later.

The encryption processing unit 212 generates encrypted storage data by subjecting the storage data received from the user computer 100 to encryption using the data encryption key. In addition, the encryption processing unit 212 generates encrypted storage embedding data by subjecting the storage embedding data received from the embedding generation server 300 to searchable encryption using the searchable encryption key.

The decryption processing unit 213 performs decryption using the data encryption key on the encrypted related data received from the data management server 400 to acquire the related data.

The search query generation unit 214 generates encrypted prompt embedding data as a search query by subjecting the prompt embedding data received from the embedding generation server 300 to encryption using the searchable encryption key.

The random shuffle unit 215 performs random shuffle using the random shuffle key on each of the encrypted storage embedding data and the search query generated by the encryption processing unit 212 and the search query generation unit 214. In the present embodiment, a common key is used as the random shuffle key.

The prompt generation unit 216 generates an input prompt based on the user prompt received from the user computer 100 and the related data acquired by the decryption processing unit 213.

In the processing of generating the input prompt, only one piece of the related data or a plurality of pieces of the related data may be used. In the input prompt, the related data may be directly reflected, or partial data extracted from the related data by a keyword search or the like may be reflected.

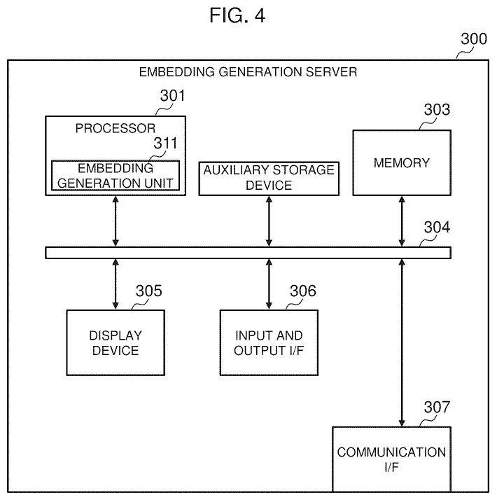

FIG. 4 is a block diagram illustrating a hardware structure example of the embedding generation server 300. In FIG. 4, the embedding generation server 300 is a computer including a processor 301, an auxiliary storage device 302, a memory 303, a display device 305, an input and output interface 306, and a communication interface 307, and the respective devices are connected to each other via an internal signal line 304 such as a bus.

Functions as hardware of the processor 301, the auxiliary storage device 302, the memory 303, the internal signal line 304, the display device 305, the input and output interface 306, and the communication interface 307 are the same as the functions as hardware of the processor 101, the auxiliary storage device 102, the memory 103, the internal signal line 104, the display device 105, the input and output interface 106, and the communication interface 107, so that the description thereof will be omitted.

The processor 301 executes a program stored in the memory 303 to implement an embedding generation unit 311 which is a functional configuration.

The embedding generation unit 311 generates, for example, encrypted storage embedding data and encrypted prompt embedding data (search query) which are embedding data corresponding to each of the storage data and the input prompt received from the prompt generation server 200.

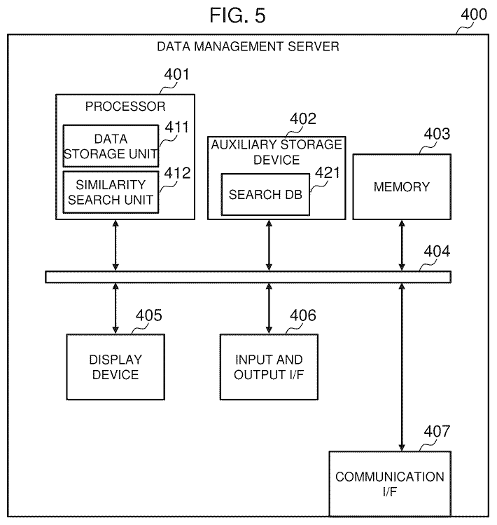

FIG. 5 is a block diagram illustrating a hardware structure example of the data management server 400. In FIG. 5, the data management server 400 is a computer including a processor 401, an auxiliary storage device 402, a memory 403, a display device 405, an input and output interface 406, and a communication interface 407, and the respective devices are connected to each other via an internal signal line 404 such as a bus.

Functions as hardware of the processor 401, the auxiliary storage device 402, the memory 403, the internal signal line 404, the display device 405, the input and output interface 406, and the communication interface 407 are the same as functional configurations as hardware of the processor 101, the auxiliary storage device 102, the memory 103, the internal signal line 104, the display device 105, the input and output interface 106, and the communication interface 107, so that the description thereof will be omitted.

The processor 401 executes a program stored in the memory 403 to implement a data storage unit 411 and a similarity search unit 412, which are functional configurations.

The auxiliary storage device 402 holds the search DB 421 that stores the encrypted storage data and the encrypted storage embedding data received by the communication interface 407 from the prompt generation server 200. The search DB 421 may be held in the memory 403.

The data storage unit 411 stores, for example, the encrypted storage data and the encrypted storage embedding data received from the prompt generation server 200 in the search DB 421 for each piece of the encrypted storage data.

The similarity search unit 412 performs a similarity search for searching the search DB 421 for the encrypted storage embedding data similar to the search query received from the prompt generation server 200, and transmits the encrypted storage data corresponding to the encrypted storage embedding data, which is a search result thereof, to the prompt generation server 200 as the encrypted related data.

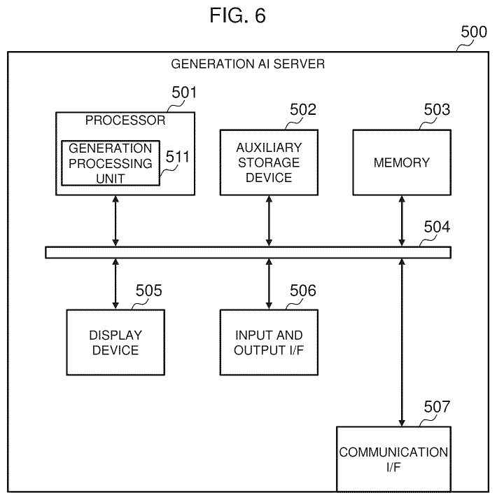

FIG. 6 is a block diagram illustrating a hardware structure example of the generation AI server. In FIG. 6, the generation AI server 500 is, for example, a computer including a processor 501, an auxiliary storage device 502, a memory 503, a display device 505, an input and output interface 506, and a communication interface 507, and the respective devices are connected to each other via an internal signal line 504 such as a bus.

Functions as hardware of the processor 501, the auxiliary storage device 502, the memory 503, the internal signal line 504, the display device 505, the input and output interface 506, and the communication interface 507 are the same as the functions as hardware of the processor 101, the auxiliary storage device 102, the memory 103, the internal signal line 104, the display device 105, the input and output interface 106, and the communication interface 107, so that the description thereof will be omitted.

The processor 501 executes a program stored in the memory 503 to implement a generation processing unit 511 which is a functional configuration.

The generation processing unit 511 includes a generation AI model, inputs the input prompt received by the communication interface 407 from the prompt generation server 200 to the generation AI model, and transmits generation data output from the generation AI model to the prompt generation server 200.

Hereinafter, the confidential similarity search, which is a similarity search using searchable encryption, will be described in more detail. The distance between the pieces of the embedding data is a Hamming distance.

First, the searchable encryption will be described.

M1 and M2 represent any values, k represents an encryption key, Enc represents an encryption function, and Search represents a search function for the similarity search. In this case, for example, Enc (M, k) indicates a ciphertext obtained by encrypting a value M with the encryption key k, and Search (X, Y) indicates a result of similarity search of a ciphertext X with a ciphertext Y. In the searchable encryption, Equation (1) is established in a case of M1=M2, and Equation (2) is established in a case of M1≠M2.

$$Search ( Enc ( M 1 , k ) , Enc ( M 2 , k ) ) = 0 \qquad ( 1 )$$

$$Search ( Enc ( M 1 , k ) , Enc ( M 2 , k ) ) = 1 \qquad ( 2 )$$

In Equation (2), regarding a case where Enc (M1, k) and Enc (M2, k) accidentally match each other in the case of M1≠M2, the occurrence probability thereof is very small and is therefore ignored.

According to the above equations (1) and (2), it can be determined whether the values M1 and M2 match each other based on the encrypted embedding data Enc (M1, k) and Enc (M2, k) of the values M1 and M2, respectively.

Hereinafter, confidential Hamming distance calculation, which is calculation of a Hamming distance using the above searchable encryption, will be described.

The Hamming distance is a distance defined for a plurality of pieces of data (bit string) having the same number of bits, and is defined as the number of bit positions having different values in the plurality of pieces of data. For example, the Hamming distance is 1 in a case of bit strings “111” and “011”, and is 2 in a case of bit strings “111” and “010”.

In the confidential Hamming distance calculation, first, each bit of the embedding data is encrypted by searchable encryption. For example, in a case where storage embedding data A is “110” and prompt embedding data B is “101”, encrypted storage embedding data Enc (A) and encrypted prompt embedding data Enc (B) are respectively

$$Enc ( A ) = Enc ( 1 ) ‖ Enc ( 1 ) ‖ Enc ( 0 ) , and$$

$$Enc ( B ) = Enc ( 1 ) ‖ Enc ( 0 ) ‖ Enc ( 1 ) .$$

The Hamming distance is the number of bits whose values match each other in the encrypted storage embedding data Enc (A) and the encrypted prompt embedding data Enc (B), and is calculated by applying a search function Search to each of bit positions corresponding to each other in the encrypted storage embedding data Enc (A) and the encrypted prompt embedding data Enc (B). For example, in the case of the above storage embedding data A “110” and prompt embedding data B “101”, when the search function Search is applied, the following equations (3) to (5) are obtained:

$$Search ( Enc ( 1 ) , Enc ( 1 ) ) = 0 ; \qquad ( 3 )$$

$$Search ( Enc ( 1 ) , Enc ( 0 ) ) = 1 ; \qquad ( 4 )$$

$$Search ( Enc ( 0 ) , Enc ( 1 ) ) = 1 , \qquad ( 5 )$$

and the Hamming distance therebetween is 2.

As described above, the confidential Hamming distance calculation using the common key-based searchable encryption can be performed. In this case, the data management server 400 calculates, for example, the Hamming distance between the search query and each piece of the encrypted storage embedding data in the search DB 421 by using the above confidential calculation, and sets the encrypted storage embedding data whose Hamming distance satisfies a predetermined criterion (for example, less than threshold value) as the encrypted storage embedding data similar to the search query, thereby realizing the confidential similarity search.

However, in the above confidential similarity search, there is a possibility that a bit having a matching value is leaked from the data management server 400 that calculates the Hamming distance. For example, in the case of the above embedding data A and B, there is a possibility that a matter that bits of a first bit match each other according to Equation (3) and a matter that bits of a second bit and a third bit are different from each other according to Equations (4) and (5) may be leaked. Therefore, in the present embodiment, random shuffle is used to conceal bits having the same value.

Specifically, the key generation unit 211 of the prompt generation server 200 generates a random shuffle key using a common key. The random shuffle unit 215 executes random shuffle for shuffling a value of each bit of the encrypted storage embedding data Enc (A) and the encrypted prompt embedding data Enc (B) using the random shuffle key. For example, when the random shuffle key is (2, 3, 1), the random shuffle is a conversion in which a first element of an operation result based on the search function is moved to a second element, the second element to a third element, and the third element to the first element. The Hamming distance remains unchanged with respect to this random shuffle.

For example, when results of performing the random shuffle on the encrypted storage embedding data Enc (A) and the encrypted prompt embedding data Enc (B) are Shuffle (A) and Shuffle (B),
Shuffle (A)=Enc (0)∥Enc (1)∥Enc (1), and
Shuffle (B)=Enc (1)∥Enc (1)∥Enc (0). When the confidential computation of the Hamming distance is performed on the Shuffle (A) and the Shuffle (B),
Search (Enc (0), Enc (1))=1,
Search (Enc (1), Enc (1))=0, and
Search (Enc (1), Enc (0))=1. Therefore, the Hamming distance is 2, which is the same as when the random shuffle is not performed.

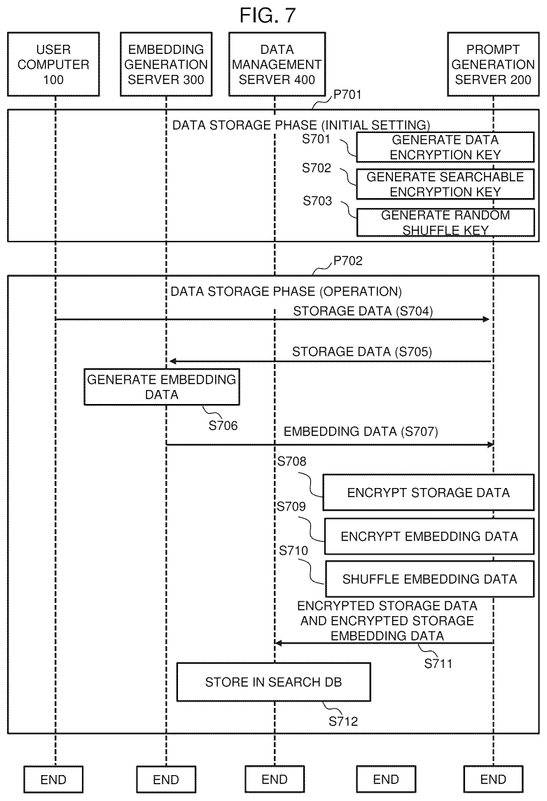

FIG. 7 is a sequence diagram illustrating an example of processing in the data storage phase of the RAG system 10. The data storage phase includes an initial setting phase P701 and an operation phase P702 as described above.

First, in the initial setting phase P701, the key generation unit 211 of the prompt generation server 200 generates a data encryption key (step S701), generates a searchable encryption key (step S702), and generates a random shuffle key (step S703). Thereafter, the operation phase P702 is started.

In the operation phase P702, first, the user computer 100 transmits the storage data to be stored in the data management server 400 to the prompt generation server 200 (step S704).

The encryption processing unit 212 of the prompt generation server 200 receives the storage data and transmits the storage data to the embedding generation server 300 (step S705). The embedding generation unit 311 of the embedding generation server 300 receives the storage data and generates storage embedding data which is embedding data corresponding to the storage data (step S706). The embedding generation unit 311 transmits the storage embedding data to the prompt generation server 200 (step S707).

Upon receiving the storage embedding data, the encryption processing unit 212 of the prompt generation server 200 generates encrypted storage data obtained by encrypting the above storage data with the data encryption key (step S708). The encryption processing unit 212 generates encrypted storage embedding data obtained by encrypting the storage embedding data with the searchable encryption key (step S709). The random shuffle unit 215 shuffles a value of each bit of the encrypted storage embedding data using the random shuffle key (step S710).

The encryption processing unit 212 transmits the encrypted storage data and the shuffled encrypted storage embedding data to the data management server 400 (step S711). Upon receiving the encrypted storage data and the encrypted storage embedding data, the data storage unit 411 of the data management server 400 stores the encrypted storage data and the encrypted storage embedding data in the search DB 421 (step S712), and ends the operation phase P702.

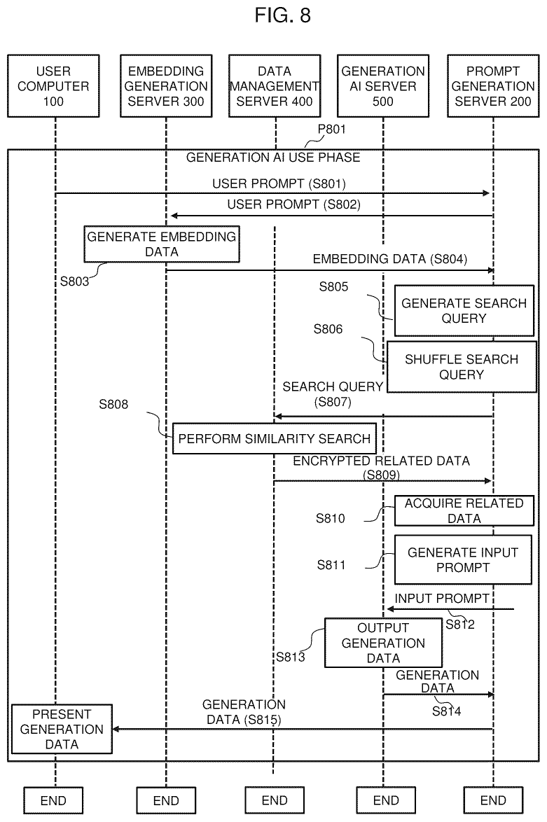

FIG. 8 is a sequence diagram illustrating an example of processing in the generation AI use phase of the RAG system 10.

In a generation AI use phase P801, first, the user computer 100 transmits a user prompt to the prompt generation server 200 (step S801). The search query generation unit 214 of the prompt generation server 200 receives the user prompt and transmits the user prompt to the embedding generation server 300 (step S802).

The embedding generation unit 311 of the embedding generation server 300 receives the user prompt and generates prompt embedding data which is embedding data corresponding to the user prompt (step S803), and the embedding generation unit 311 transmits the prompt embedding data to the prompt generation server 200 (step S804).

The search query generation unit 214 of the prompt generation server 200 receives the prompt embedding data, and generates, as a search query, encrypted prompt embedding data obtained by encrypting the prompt embedding data with the searchable encryption key (step S805). The random shuffle unit 215 shuffles a value of each bit of the search query with the random shuffle key (step S806). The search query generation unit 214 transmits the shuffled search query to the data management server 400 (step S807).

Upon receiving the search query, the similarity search unit 412 of the data management server 400 performs a similarity search for searching the search DB 421 for encrypted storage embedding data similar to the search query (step S808). The similarity search unit 412 acquires the encrypted storage data corresponding to the searched encrypted storage embedding data from the search DB 421 as encrypted related data and transmits the encrypted storage data to the prompt generation server 200 (step S809).

The decryption processing unit 213 of the prompt generation server 200 receives the encrypted related data, decrypts the encrypted related data with the data encryption key, and acquires related data (step S810). The prompt generation unit 216 generates an input prompt based on the related data and the user prompt (step S811), and transmits the input prompt to the generation AI server 500 (step S812).

Upon receiving the input prompt, the generation processing unit 511 of the generation AI server 500 inputs the input prompt to the generation AI model, and acquires generation data output from the generation AI model (step S813).

The generation processing unit 511 transmits the generation data to the prompt generation server 200 (step S814). Upon receiving the generation data, the prompt generation unit 216 of the prompt generation server 200 transmits the generation data to the user computer 100 (step S815). Upon receiving the generation data, the user computer 100 presents the generation data to the user (step S816), and ends the generation AI use phase P801.

According to the present embodiment described above, the prompt generation server 200 stores encrypted storage data obtained by encrypting the storage data with a common key and encrypted storage embedding data obtained by encrypting the storage embedding data indicating a feature of the storage data with a searchable encryption key for each piece of storage data in the search DB 421. The prompt generation server 200 generates encrypted prompt embedding data obtained by encrypting the prompt embedding data indicating a feature of the user prompt with the searchable encryption key, and transmits the encrypted prompt embedding data to the data management server 400. The prompt generation server 200 receives encrypted related data which is encrypted storage data corresponding to the encrypted storage embedding data similar to the encrypted target embedding data, decrypts the encrypted related data with the common key, and acquires the related data.

In this case, only the encrypted data (encrypted storage data and encrypted storage embedding data) needs to be stored in the data management server 400, and a reliable private key holder of a third party does not need to decrypt a search result of the data management server 400. Therefore, a secure and efficient confidential similarity search can be performed. Therefore, for example, it is possible to prevent information leakage due to malicious or negligence of an administrator of the data management server 400.

In the present embodiment, the prompt generation server 200 generates the input prompt from the acquired related data and the user prompt, inputs the input prompt to the generation AI model, and presents the generation data output from the generation AI model to the user. Therefore, a secure and efficient confidential similarity search can be used for a similarity search for retrieval augmented generation, and thus secure retrieval augmented generation can be performed.

In the present embodiment, each bit of the encrypted storage embedding data and the encrypted prompt embedding data is shuffled and transmitted to the data management server 400. Therefore, leakage of information such as a position where the bits of the encrypted storage embedding data and the encrypted prompt embedding data match can be prevented, and thus the security can be further improved.

In the present embodiment, the data management server 400 sets an encrypted storage embedding data whose distance from the encrypted target embedding data satisfies a predetermined criterion as the encrypted storage embedding data similar to the encrypted target embedding data. The distance is, for example, a Hamming distance. In this case, it is possible to search for more appropriate encrypted storage data.

In the present embodiment, the embedding generation server 300 generates the storage embedding data and the prompt embedding data based on the storage data and the user prompt. The prompt generation server 200 encrypts the storage embedding data and the prompt embedding data generated by the embedding generation server 300. By using the reliable embedding generation server 300 such as an own company server, a load of the prompt generation server 200 can be reduced while maintaining the security.

The present disclosure is not limited to the embodiment described above and includes various modifications. For example, the above embodiments have been described in detail to facilitate understanding of the invention, and the invention is not necessarily limited to those including all the configurations described above.

Some or all of the configurations, the function units, and the like described above may be implemented by hardware by, for example, performing design with an integrated circuit. In addition, the configurations, functions, and the like described above may be implemented by software by a processor interpreting and executing a program for implementing each function. Information such as a program, a table, and a file for implementing each function can be stored in a recording device such as a memory, a hard disk, and a solid state drive (SSD) or a recording medium such as an IC card, an SD card, and a digital versatile disc (DVD).

Control lines and information lines indicate what is considered to be necessary for description, and not necessarily all control lines and information lines are always shown on a product. Actually, it may be considered that almost all the configurations are connected to one another.

What is claimed is:

1. A search management device for acquiring related data related to search target data, wherein
encrypted storage data obtained by encrypting storage data serving as a candidate for the related data and encrypted storage embedding data obtained by encrypting storage embedding data indicating a feature of the storage data with a searchable encryption key are generated for each piece of the storage data and stored in a database,
encrypted target embedding data obtained by encrypting target embedding data indicating a feature of the search target data with the searchable encryption key is generated and transmitted to a data management device, the data management device searching the database for encrypted storage data corresponding to the encrypted d storage embedding data similar to the encrypted target embedding data,
the encrypted storage data searched for by the data management device is acquired as encrypted related data obtained by encrypting the related data, and
the encrypted related data is decrypted to acquire the related data.

2. The search management device according to claim 1, wherein
the search target data is a user prompt for a generation AI model from a user, and
the search management device is configured to
generate an input prompt to be input to the generation AI model based on the user prompt and the related data, and input the input prompt to the generation AI model, and
present generation data output from the generation AI model to the user.

3. The search management device according to claim 1, wherein
in storing the encrypted storage data, each bit of the encrypted storage embedding data is shuffled with a shuffle key for shuffling each bit of data and stored in the data management device, and
in transmitting the encrypted target embedding data, each bit of the encrypted target embedding data is shuffled with the shuffle key and transmitted to the data management device.

4. A computer system comprising:
the search management device according to claim 1, and
the data management device.

5. The computer system according to claim 4, wherein
the data management device is configured to set an encrypted storage embedding data whose distance from the encrypted target embedding data satisfies a predetermined criterion as the encrypted storage embedding data similar to the encrypted target embedding data.

6. The computer system according to claim 5, wherein
the distance is a Hamming distance.

7. The computer system according to claim 4, further comprising:
an embedding generation device configured to generate the storage embedding data and the target embedding data based on the storage data and the search target data, wherein
the search management device is configured to encrypt the storage embedding data and target embedding data generated by the embedding generation device with the searchable encryption key to generate the encrypted storage embedding data and the encrypted target embedding data.

8. A search management method performed by a search management device configured to acquire related data related to search target data, the search management method comprising:
generating, for each piece of the storage data, encrypted storage data obtained by encrypting storage data serving as a candidate for the related data and encrypted storage embedding data obtained by encrypting storage embedding data indicating a feature of the storage data with a searchable encryption key, and storing the encrypted storage data and the encrypted storage embedding data in a database;
generating encrypted target embedding data obtained by encrypting target embedding data indicating a feature of the search target data with the searchable encryption key, and transmitting the encrypted target embedding data to a data management device, the data management device searching the database for encrypted storage data corresponding to the encrypted storage embedding data similar to the encrypted target embedding data;
acquiring the encrypted storage data searched for by the data management device as encrypted related data obtained by encrypting the related data; and
decrypting the encrypted related data to acquire the related data.
